(19) United States
(12) Patent Application Publication
(10) Pub. No.: US 2026/0184944 A1
(43) Pub. Date: Jul. 2, 2026

(54) Composition Set And Ink Jet Recording Method

(71) Applicant: SEIKO EPSON CORPORATION, Tokyo (JP)

(72) Inventor: Kosuke CHIDATE, Shiojiri (JP)

(21) Appl. No.: 19/430,705

(22) Filed: Dec. 23, 2025

(30) Foreign Application Priority Data
Dec. 26, 2024 (JP) 2024-231053

(51) Int. Cl. C09D 11/322; B41J 2/21; B41J 3/407; B41J 11/00

(52) U.S. Cl. CPC C09D 11/322; B41J 2/2117; B41J 3/4078; B41J 11/0015

(57) ABSTRACT

A composition set according to an embodiment of the present disclosure includes a textile printing white ink jet ink composition, a textile printing clear ink jet ink composition, and a treatment liquid composition, in which the textile printing white ink jet ink composition contains a titanium oxide pigment and water, the textile printing clear ink jet ink composition contains a resin particle and water, and the treatment liquid composition contains a particle containing organopolysiloxane and water.

The present application is based on, and claims priority from JP Application Serial Number 2024-231053, filed Dec. 26, 2024, the disclosure of which is hereby incorporated by reference herein in its entirety.

### BACKGROUND

### 1. Technical Field

The present disclosure relates to a composition set and an ink jet recording method.

### 2. Related Art

An ink jet method is applied to not only recording of an image on paper or the like but also textile printing on a fabric. In particular, in ink jet textile printing using a pigment, there are various studies for improving a color developing property and rubbing fastness of an image printed on the fabric.

For example, JP-A-2017-149812 discloses an overcoat liquid for ink jet textile printing to be used in combination with a pigment ink.

However, there is still room for improvement in the rubbing fastness, and there is an issue in achieving a favorable color developing property and texture while achieving favorable rubbing fastness.

### SUMMARY

According to an aspect of the present disclosure, there is provided a composition set including a textile printing white ink jet ink composition, a textile printing clear ink jet ink composition, and a treatment liquid composition, in which the textile printing white ink jet ink composition contains a titanium oxide pigment and water, the textile printing clear ink jet ink composition contains a resin particle and water, and the treatment liquid composition contains a particle containing organopolysiloxane and water.

According to another aspect of the present disclosure, there is provided an ink jet recording method performed using the composition set of the aspect, including a white ink jet ink application step of applying the textile printing white ink jet ink composition to a fabric using an ink jet method, a treatment liquid application step of applying the treatment liquid composition to a region of the fabric to which the textile printing white ink jet ink composition is applied, and a clear ink application step of applying the textile printing clear ink jet ink composition to the region of the fabric to which the textile printing white ink jet ink composition is applied.

### BRIEF DESCRIPTION OF THE DRAWINGS

FIG. 1 is a perspective view of a serial printer.

FIG. 2 is a schematic diagram showing an example of nozzle array disposition of an ink jet head.

FIG. 3 is a schematic side view of a line printer.

FIG. 4 shows Table 1 showing a composition set according to each example and an evaluation result.

FIG. 5 shows Table 2 showing a composition set according to each example and an evaluation result.

### DESCRIPTION OF EMBODIMENTS

Hereinafter, an embodiment of the present disclosure will be described. The embodiment set forth below describes an example of the present disclosure. The present disclosure is not limited to the following embodiment and includes various modifications implemented without changing the gist of the present disclosure. Not all of the configurations described below are configurations essential to the present disclosure.

In the present specification, a numerical value range represented using “to” means a range including numerical values shown before and after “to” as a lower limit value and an upper limit value.

In the present specification, “(meth)acrylic” means acrylic or methacrylic, and “(meth)acrylate” means acrylate or methacrylate.

In the present specification, “textile printing” refers to recording/printing of an ink on a recording medium including a fabric and is also referred to as “printing”. The recording medium after textile printing will be referred to as a “textile-printed matter” or a “printed matter”.

### 1. Composition Set

A composition set according to an embodiment of the present disclosure includes a textile printing white ink jet ink composition, a textile printing clear ink jet ink composition, and a treatment liquid composition, in which the textile printing white ink jet ink composition contains a titanium oxide pigment and water, the textile printing clear ink jet ink composition contains a resin particle and water, and the treatment liquid composition contains a particle containing organopolysiloxane and water.

The textile printing white ink jet ink composition (hereinafter, also referred to as a “white ink”) may contain a relatively large amount of pigment to improve a property of covering a base. Meanwhile, when a large amount of pigment is contained, rubbing fastness is likely to deteriorate. Thus, it is conceivable that the white ink also contains a large amount of resin particles. However, when a solid content in the ink increases, reliability of ink jet ejection tends to decrease, and the solid content cannot be easily increased. Furthermore, when the white ink contains a large amount of resin particles, achieving favorable texture of the textile-printed matter tends to be difficult. Accordingly, in ink jet textile printing using the white ink, it is difficult to achieve compatibility among a color developing property, rubbing fastness, and texture.

Meanwhile, it is also conceivable to separate functions using the clear ink jet ink composition (hereinafter, also referred to as a “clear ink”) containing the resin particle. However, simply using the clear ink cannot achieve sufficient rubbing fastness, and there is still room for improvement. Specifically, while use of the clear ink tends to strengthen a coating, the white ink and the clear ink are likely to peel off from an interface with respect to the fabric for each ink layer. In particular, dry rubbing fastness deteriorates. Since the clear ink also needs to be applied in addition to the white ink of which an application amount tends to be large, an ink coating film is expected to be increased in thickness and easily peel off.

Meanwhile, when a treatment liquid containing a particle containing organopolysiloxane is used, a coefficient of friction on a surface of the textile-printed matter is reduced, and, for example, smoothness is improved. Accordingly, peeling of the ink coating layer is reduced, and favorable rubbing fastness (in particular, dry rubbing fastness) can be achieved. In addition, for example, since smoothness of a surface of an ink coating is improved, and the particle containing organopolysiloxane is present in a resin coating, the coating is softened. Accordingly, texture of the textile-printed matter can be favorably maintained.

Thus, according to the composition set according to the present embodiment, a favorable color developing property and texture can be achieved while achieving more favorable rubbing fastness.

Hereinafter, each composition in the composition set according to the present embodiment will be described.

The “composition set” according to the present embodiment is not limited to being manufactured, sold, or the like in an integrated state as long as a textile printing ink jet ink composition and a treatment liquid composition are used as a set in recording. For example, when independently manufactured or sold compositions are assumed to be used in combination or substantially supposed to be used in combination, the compositions are included in a set.

### 1.1 Textile Printing White Ink Jet Ink Composition

The composition set according to the present embodiment includes the textile printing white ink jet ink composition containing the titanium oxide pigment and the water.

In the present specification, the term “white” in the textile printing white ink jet ink composition means not only a completely white color but also a range of colors colored with a chromatic color or an achromatic color and glossy colors visible as white. Inks or coloring materials that are named and sold with names regarded as a white ink or a white coloring material are also included.

More quantitatively, for example, “white” includes not only a color of which L* is 100, but also a color of which L* is 60 or more and 100 or less, and each of a* and b* is +10 or less in CIELAB on a recorded matter.

Hereinafter, each component contained in the textile printing white ink jet ink composition will be described.

### 1.1.1 Titanium Oxide Pigment

The textile printing white ink jet ink composition contains the titanium oxide pigment.

Examples of the titanium oxide pigment include C.I. Pigment White 6 made of titanium dioxide and C.I. Pigment White 6:1 made of titanium dioxide containing other metal oxides. Among the examples, C.I. Pigment White 6 providing an enhanced color developing property, a masking property, and the like is preferably used.

A form of the titanium oxide pigment is not particularly limited. Examples thereof include an amorphous form, an anatase crystal form, and a rutile crystal form. From a viewpoint of further improving a shielding property, the rutile crystal form is preferably used.

A commercially available product of the titanium oxide pigment may be used. Examples of the commercially available product include CR-50, CR-50-2, CR-57, CR-Super70, CR-80, CR-90, CR-90-2, CR-93, CR-95, CR-953, CR-97, R-820, R-830, R-930, UT771, and PFC105 (all product names) manufactured by Ishihara Sangyo Co., Ltd., and R-38L (product name) manufactured by Sakai Chemical Industry Co., Ltd. One type of these commercially available products can be used alone, or two or more types of the commercially available products can be used in combination.

An average particle diameter of the titanium oxide pigment is preferably 100 nm or more and 500 nm or less, more preferably 50 nm or more and 450 nm or less, and further preferably 200 nm or more and 400 nm or less. When the average particle diameter of the titanium oxide pigment is within this range, stability of ejection from the ink jet head tends to be secured. In addition, the masking property tends to be improved.

In the present specification, unless otherwise specified, the “average particle diameter” means a volume-based particle size distribution that is a particle diameter at 50% by volume cumulative distribution. The average particle diameter is measured using the dynamic light scattering method or the laser diffraction light method according to JIS Z8825. Specifically, a particle size distribution meter (for example, “Microtrac UPA” manufactured by Nikkiso Co., Ltd.) using the dynamic light scattering method as a measurement principle can be adopted.

The titanium oxide pigment may be used after dispersing the titanium oxide pigment using a pigment dispersant. The titanium oxide pigment may be used after dispersing the titanium oxide pigment as a self-dispersing pigment by oxidizing a surface of the pigment using ozone or the like.

The pigment dispersant has a function of dispersing the pigment in the ink. The pigment dispersant may be water-soluble but is preferably not completely water-soluble. The pigment dispersant is considered to disperse the pigment by bonding to or adsorbing on the pigment in part or as a whole to increase hydrophilicity of a surface of the pigment.

The pigment dispersant is a polymer compound, and examples of the polymer compound include an acrylic resin such as poly(meth)acrylic acid, a (meth)acrylic acid-acrylonitrile copolymer, a (meth)acrylic acid-(meth)acrylate copolymer, a vinyl acetate-(meth)acrylate copolymer, a vinyl acetate-(meth)acrylic acid copolymer, a vinylnaphthalene-(meth)acrylic acid copolymer, a styrene-(meth)acrylic acid copolymer, a styrene-(meth)acrylic acid-(meth)acrylate copolymer, a styrene-α-methylstyrene-(meth)acrylic acid copolymer, and a styrene-α-methylstyrene-(meth)acrylic acid-(meth)acrylate copolymer and a salt thereof.

Examples of the pigment dispersant also include a maleic acid-based resin such as a styrene-maleic acid copolymer, a styrene-maleic anhydride copolymer, a vinylnaphthalene-maleic acid copolymer, and a vinyl acetate-maleate copolymer and a salt thereof; a urethane-based resin with or without a cross-linked structure and a salt thereof; polyvinyl alcohols; and a vinyl acetate-crotonic acid copolymer and a salt thereof.

The acrylic resin may include not only a polymer of an acrylic monomer as described above, but also a copolymer of an acrylic monomer and another monomer. For example, an acrylic vinyl resin of a copolymer with a vinyl-based monomer as the other monomer is also referred to as the acrylic resin. The acrylic resin also includes, for example, a copolymer of a styrene-based monomer and an acrylic monomer among the styrene-based resins. The acrylic resin also includes a salt and an esterified product thereof.

Examples of a commercially available product of the pigment dispersant include X-200, X-1, X-205, X-220, and X-228 (manufactured by Seiko PMC Corporation), Nopco Sperse (registered trademark) 6100 and 6110 (manufactured by San Nopco Ltd.), Joncryl 67, 586, 611, 678, 680, 682, and 819 (manufactured by BASF), DISPERBYK-190 (manufactured by BYK Chemie Japan Co., Ltd.), and N-EA137, N-EA157, N-EA167, N-EA177, N-EA197D, N-EA207D, and E-EN10 (manufactured by DKS Co., Ltd.).

Examples of a commercially available product of the acrylic pigment dispersant include BYK-187, BYK-190, BYK-191, BYK-194N, and BYK-199 (manufactured by BYK Chemie Japan Co., Ltd.) and Aron A-210, A6114, AS-1100, AS-1800, A-30SL, A-7250, and CL-2 (manufactured by Toagosei Co., Ltd.).

Examples of a commercially available product of the urethane-based pigment dispersant include BYK-182, BYK-183, BYK-184, and BYK-185 (manufactured by BYK Chemie Japan Co., Ltd.), TEGO Disperse 710 (manufactured by Evonik Tego Chemie GmbH), and Borchi (registered trademark) Gen 1350 (manufactured by OMG Borschers GmbH).

The pigment dispersant is preferably an anionic pigment dispersant. The “anionic pigment dispersant” means a pigment dispersant having a negative charge as a whole pigment dispersant and preferably has one or more anionic groups selected from a carboxyl group, a sulfonic acid group, a phosphoric acid group, and the like.

One type of the pigment dispersant may be used alone, or two or more types of the pigment dispersant may be used in combination. A total content of the pigment dispersant is preferably 0.1% by mass or more and 30% by mass or less, more preferably 0.5% by mass or more and 25% by mass or less, further preferably 18 by mass or more and 20% by mass or less, and particularly preferably 1.5% by mass or more and 15% by mass or less with respect to 100% by mass of the textile printing white ink jet ink composition. When the content of the pigment dispersant is 0.1% by mass or more, stability of dispersion of the titanium oxide pigment tends to be secured. When the content of the pigment dispersant is 308 by mass or less, viscosity of the textile printing white ink jet ink composition tends to be further reduced.

A weight average molecular weight of the pigment dispersant is further preferably 500 or more. Using such a pigment dispersant reduces odor, and further favorable stability of dispersion of the pigment tends to be achieved.

When the titanium oxide pigment is dispersed by the pigment dispersant, a ratio of the titanium oxide pigment to the pigment dispersant is preferably 10:1 to 1:10 and more preferably 4:1 to 1:3.

From a viewpoint of further enhancing the color developing property, a content of the titanium oxide pigment is preferably 1.0% by mass or more, more preferably 3.0% by mass or more, further preferably 5.0% by mass or more, still more preferably 7.0% by mass or more, particularly preferably 8.3% by mass or more, and more particularly preferably 9.0% by mass or more with respect to a total amount of the textile printing white ink jet ink composition.

From a viewpoint of further enhancing rubbing fastness and stability of continuous printing, the content of the titanium oxide pigment is preferably 30.08 by mass or less, more preferably 20.0% by mass or less, further preferably 15.0% by mass or less, particularly preferably 11.8% by mass or less, and more particularly preferably 11.0% by mass or less with respect to the total amount of the textile printing white ink jet ink composition.

When the content of the titanium oxide pigment is within this range, in particular, 8.3% to 11.8% by mass with respect to the total amount of the textile printing white ink jet ink composition, compatibility between a favorable color developing property and favorable rubbing fastness and stability of continuous printing tends to be achieved.

### 1.1.2 Water

The textile printing white ink jet ink composition contains the water. Examples of the water include pure water such as ion-exchanged water, ultrafiltered water, reverse osmosis water, and distilled water, and water having reduced ionic impurities, such as ultrapure water. When water sterilized through ultraviolet irradiation, addition of hydrogen peroxide, or the like is used, generation of bacterium or fungi when the reactive liquid is stored for a long term can be reduced.

A content of the water is preferably 30% by mass or more, further preferably 40% by mass or more, more preferably 50% by mass or more, and particularly preferably 60% by mass or more with respect to the total amount of the textile printing white ink jet ink composition. An upper limit of the content of the water is not particularly limited and is, for example, preferably 90% by mass or less, further preferably 80% by mass or less, and more preferably 70% by mass or less with respect to the total amount of the textile printing white ink jet ink composition.

### 1.1.3 Resin Particle

The textile printing white ink jet ink composition may contain a resin particle. The resin particle can be the same as the resin particle contained in the textile printing clear ink jet ink composition described later. The resin particle in the textile printing white ink jet ink composition can be selected independently of the resin particle contained in the textile printing clear ink jet ink composition described later.

A content of the resin particle is preferably 3.0% to 20.0% by mass, more preferably 5.0% to 15.0% by mass, and further preferably 7.0% to 13.0% by mass with respect to the total amount of the textile printing white ink jet ink composition.

The white ink preferably contains a large amount of resin particles. However, from a viewpoint of reliability of ink jet ejection and texture, it is difficult to simply contain a large amount of resin particles. Furthermore, simply using the clear ink cannot achieve sufficient rubbing fastness. Meanwhile, according to the composition set according to the present embodiment, even when the content of the resin particle in the textile printing white ink jet ink composition is within the above range, more favorable rubbing fastness tends to be achieved.

A content of the resin particle in the textile printing clear ink jet ink composition described later is preferably 1.0 or more, more preferably 1.2 or more, further preferably 1.3 or more, and particularly preferably 1.5 or more with respect to the content of the resin particle in the textile printing white ink jet ink composition. An upper limit is not particularly limited and is preferably 2.5 or less, more preferably 2.0 or less, and particularly preferably 1.8 or less.

When the content of the resin particle in the textile printing clear ink jet ink composition, described later, with respect to the content of the resin particle in the textile printing white ink jet ink composition is within this range, particularly 1.2 or more, more favorable rubbing fastness tends to be achieved.

### 1.1.4 Organic Solvent

The textile printing white ink jet ink composition may contain an organic solvent. Examples of the organic solvent include esters, glycol ethers, cyclic esters, amides, alcohols, and polyhydric alcohols.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, and dipropylene glycol acetate propionate.

Examples of the glycol ethers include monoether or diether of alkylene glycol.

Examples of the monoether of alkylene glycol include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, 3-methoxy-3-methylbutanol, and 3-methoxy-butanol.

Examples of the diether of alkylene glycol include alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone, and compounds thereof in which hydrogen of a methylene group adjacent to a carbonyl group is substituted with an alkyl group having a carbon number of 1 to 4.

Examples of the amides include cyclic amides and acyclic amides. Examples of the acyclic amides include alkoxyalkylamides.

Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl) pyrrolidin-2-one.

Examples of the alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, 3-n-butoxy-N, N-methylethylpropionamide, 3-n-propoxy-N, N-dimethylpropionamide, 3-n-propoxy-N, N-diethylpropionamide, 3-n-propoxy-N, N-methylethylpropionamide, 3-iso-propoxy-N, N-dimethylpropionamide, 3-iso-propoxy-N, N-diethylpropionamide, 3-iso-propoxy-N, N-methylethylpropionamide, 3-tert-butoxy-N, N-dimethylpropionamide, 3-tert-butoxy-N, N-diethylpropionamide, 3-tert-butoxy-N, N-methylethylpropionamide, and N, N-dimethylisobutyrate amide.

Examples of the alcohols include a compound in which one hydrogen atom of alkane is substituted with a hydroxyl group. A carbon number of the alkane is preferably 10 or less, more preferably 6 or less, and further preferably 3 or less. The carbon number of the alkane is 1 or more and preferably 2 or more. The alkane may be of a linear type or a branched type. Examples of the alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, and phenoxy propanol.

The polyhydric alcohols have two or more hydroxyl groups in their molecules. Examples of the polyhydric alcohols include alkanediols and polyols.

The polyhydric alcohols may have a carbon-hydrogen skeleton and two or more hydroxyl groups in their molecules and have an ether-bonded oxygen atom. Structures other than these structures are preferably not included.

Examples of the alkanediols include a compound in which the alkane is substituted with two hydroxyl groups. Examples of the alkanediols include 1,2-alkanediol, which is a general term for compounds in which hydroxyl groups are substituted at the first and second positions of the alkane, and other alkanediols other than the 1,2-alkanediol. The 1,2-alkanediol is preferably used.

Carbon numbers of the alkanediols are preferably 2 or more and more preferably 3 to 10. The carbon numbers are preferably 5 or more and more preferably 5 to 8. Meanwhile, the carbon numbers are also preferably 4 or less.

Examples of the 1,2-alkanediol include ethylene glycol, 1,2-propanediol (propylene glycol), 1,2-butanediol, 1,2-pentanediol (1,2PD), 1,2-hexanediol, 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of the other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, and 2-methyl-2-propyl-1,3-propanediol.

Examples of the polyols include a condensate in which two or more molecules of the alkanediols are intermolecularly condensed between hydroxyl groups, and a compound having three or more hydroxyl groups.

Examples of the condensate in which two or more molecules of the alkanediols are intermolecularly condensed between hydroxyl groups include dialkylene glycol such as diethylene glycol and dipropylene glycol, and trialkylene glycol such as triethylene glycol and tripropylene glycol.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1,2,5-hexanetriol, 1,2,6-hexanetriol, pentaerythritol, and polyoxypropylenetriol.

One type of the organic solvent may be used alone, or two or more types of the organic solvent may be used in combination.

The organic solvent preferably includes polyhydric alcohols, more preferably includes polyols, and further preferably includes one or more selected from glycerin and triethylene glycol. When the organic solvent contains these solvents, the color developing property, rubbing fastness, and texture may be further enhanced.

The organic solvent preferably contains an organic solvent having a standard boiling point greater than 280° C. When the organic solvent contains an organic solvent having a standard boiling point greater than 280° C., the color developing property, rubbing fastness, and texture may be further enhanced. Examples of the organic solvent having a standard boiling point greater than 280° C. include triethylene glycol and glycerin.

A content of the organic solvent is preferably 3% to 50% by mass, more preferably 5% to 40% by mass, further preferably 10% to 30% by mass, and particularly preferably 12% to 20% by mass with respect to the total amount of the textile printing white ink jet ink composition. When the content of the organic solvent is within this range, the color developing property, rubbing fastness, and texture may be further enhanced. The content of the organic solvent having a standard boiling point greater than 280° C. is also preferably within this range.

### 1.1.5 Surfactant

The textile printing white ink jet ink composition may contain a surfactant. The surfactant can be used to reduce surface tension of the textile printing white ink jet ink composition, for example, to adjust and improve permeability of the fabric. As the surfactant, any of a nonionic surfactant, an anionic surfactant, a cationic surfactant, and an amphoteric surfactant can be used, and these may also be used in combination. Among these surfactants, an acetylene-based surfactant (acetylene glycol-based surfactant), a silicone-based surfactant, and a fluorine-based surfactant can be more preferably used, and the acetylene-based surfactant can be further preferably used.

The acetylene glycol-based surfactant is not particularly limited and is, for example, preferably one or more selected from an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol. A commercially available product of the acetylene glycol-based surfactant is not particularly limited. Examples thereof include Surfinol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (all product names, manufactured by Air Products Japan Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, AE-3 (all product names, manufactured by Nissin Chemical Industry Co., Ltd.), and acetylenol E00, E00P, E40, E100 (all product names, manufactured by Kawaken Fine Chemicals Co., Ltd.). One type of the acetylene glycol-based surfactant may be used alone, or two or more types of the acetylene glycol-based surfactant may be used in combination.

The silicone-based surfactant is not particularly limited. Examples thereof include a polysiloxane-based compound and polyether-modified organosiloxane. A commercially available product of the silicone-based surfactant is not particularly limited. Examples thereof include BYK-306, BYK-307, BYK-333, BYK-341, BYK-345, BYK-346, BYK-348, and BYK-349 (product names, manufactured by BYK Chemie Japan Co., Ltd.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (product names, manufactured by Shin-Etsu Chemical Co., Ltd.), and Silface SAG503A and Silface SAG014 (product names, manufactured by Nissin Chemical Industry Co., Ltd.). One type of the silicone-based surfactant may be used alone, or two or more types of the silicone-based surfactant may be used in combination.

The fluorine-based surfactant is not particularly limited. Examples thereof include perfluoroalkyl sulfonate, perfluoroalkyl carboxylate, perfluoroalkyl phosphate, a perfluoroalkyl ethylene oxide adduct, perfluoroalkyl betaine, and a perfluoroalkylamine oxide compound. A commercially available product of the fluorine-based surfactant is not particularly limited. Examples thereof include S-144 and S-145 (product names, manufactured by AGC Inc.); FC-170C, FC-430, Fluorad-FC4430 (product names, manufactured by Sumitomo 3M Co., Ltd.); FSO, FSO-100, FSN, FSN-100, and FS-300 (product names, manufactured by Dupont); and FT-250 and 251 (product names, manufactured by Neos Co., Ltd.). One type of the fluorine-based surfactant may be used alone, or two or more types of the fluorine-based surfactant may be used in combination.

One type of the surfactant may be used alone, or two or more types of the surfactant may be used in combination.

A content of the surfactant is preferably 5.0% by mass or less, more preferably 3.0% by mass or less, further preferably 2.0% by mass or less, particularly preferably 1.0% by mass or less, and more particularly preferably 0.5% by mass or less with respect to the total amount of the textile printing white ink jet ink composition. When the content of the surfactant is within this range, the color developing property, rubbing fastness, and texture may be further enhanced.

A lower limit of the content of the surfactant is not particularly limited and is preferably 0.1% by mass or more, further preferably 0.3% by mass or more, and more preferably 0.5% by mass or more with respect to the total amount of the textile printing white ink jet ink composition.

### 1.1.6 pH Adjuster

The textile printing white ink jet ink composition may contain a pH adjuster.

The pH adjuster is not particularly limited. Examples thereof include an appropriate combination of an acid, a base, a weak acid, and a weak base.

As examples of the acid and the base used in such a combination, examples of an inorganic acid include sulfuric acid, hydrochloric acid, and nitric acid. Examples of an inorganic base include lithium hydroxide, sodium hydroxide, potassium hydroxide, potassium dihydrogen phosphate, disodium hydrogen phosphate, potassium carbonate, sodium carbonate, sodium hydrogen carbonate, and ammonia. Examples of an organic base include triethanol amine, diethanol amine, monoethanol amine, tripropanol amine, triisopropanol amine, diisopropanol amine, and tris(hydroxymethyl)aminomethane (THAM). Examples of an organic acid include Good's buffers such as adipic acid, citric acid, succinic acid, lactic acid, N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer liquid, a citrate buffer liquid, and a Tris buffer liquid. Among the examples, the inorganic base is preferably used, and potassium hydroxide is more preferably used.

One type of the pH adjuster may be used alone, or two or more types of the pH adjuster may be used in combination.

A total content of the pH adjuster is preferably 3.00% by mass or less, more preferably 1.00% by mass or less, further preferably 0.50% by mass or less, particularly preferably 0.30% by mass or less, and more particularly preferably 0.20% by mass or less with respect to the total amount of the textile printing white ink jet ink composition. A lower limit of the total content of the pH adjuster is not particularly limited and is preferably 0.01% by mass or more, further preferably 0.05% by mass or more, and more preferably 0.10% by mass or more with respect to the total amount of the textile printing white ink jet ink composition.

### 1.1.7 Other Components

The textile printing white ink jet ink composition may contain various additives such as a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 18 by mass with respect to the total amount of the textile printing white ink jet ink composition.

### 1.1.8 Physical Property

Viscosity of the textile printing white ink jet ink composition is preferably 1.0 to 15 mPas, more preferably 1.5 to 8 mPas, and further preferably 1.5 to 5.5 mPas at 20° C. When the viscosity is 1.0 mPas or more, a more favorable color developing property tends to be achieved. When the viscosity is 15 mPa·s or less, more favorable stability of continuous printing tends to be achieved.

From a viewpoint of achieving appropriate wettability for the fabric, surface tension of the textile printing white ink jet ink composition is preferably 10 to 40 mN/m, more preferably 15 to 35 mN/m, further preferably 20 to 30 mN/m, and particularly preferably 25 to 30 mN/m at 20° C.

### 1.2 Textile Printing Clear Ink Jet Ink Composition

The composition set according to the present embodiment includes the textile printing clear ink jet ink composition containing the resin particle and the water. Hereinafter, each component contained in the textile printing clear ink jet ink composition will be described.

### 1.2.1 Resin Particle

The textile printing clear ink jet ink composition contains the resin particle. The resin particle has a function as a so-called fixing resin of improving adhesion of the ink applied to the fabric. The resin particle also has a function of reacting with a second treatment liquid composition, described later, to agglomerate and thickening the textile printing clear ink jet ink composition. While the resin particle is generally handled in an emulsion form, the resin particle may have a property of powder.

The resin particle is preferably anionic. Here, the resin particle being “anionic” means a resin particle having a negative charge as a whole resin particle. The resin particle preferably has one or more anionic groups selected from a carboxyl group, a sulfonic acid group, a phosphoric acid group, and the like.

Examples of the resin particle include resin particles consisting of a urethane resin, an acryl resin (including a styrene-acryl resin), a fluorene resin, an olefin resin, a rosin-modified resin, a terpene resin, an ester resin, an amide resin, an epoxy resin, a vinyl chloride resin, a vinyl chloride-vinyl acetate copolymer, an ethylene vinyl acetate resin, and the like. Among the examples, the urethane resin, the acryl resin, the olefin resin, and the ester resin are preferably used. One type of the resin particle may be used alone, or two or more types of the resin particle may be used in combination.

The urethane resin is a general term for resins having a urethane bond. A polyether-type urethane resin including an ether bond in a main chain, an ester-type urethane resin including an ester bond in a main chain, a carbonate-type urethane resin including a carbonate bond in a main chain, or the like other than the urethane bond may also be used as the urethane resin. A commercially available product of the urethane resin may be used. Examples thereof include Superflex 460, 460s, 840, and E-4000 (product names, manufactured by DKS Co., Ltd.), Resamine D-1060, D-2020, D-4080, D-4200, D-6300, and D-6455 (product names, manufactured by Dainichiseika Color & Chemicals MFG Co., Ltd.), Takelac WS-5100, WS-6021, and W-512-A-6 (product names, manufactured by Mitsui Chemicals Polyurethanes, Inc.), Sancure 2710 (product name, manufactured by LUBRIZOL), and Permarin UA-150 (product name, manufactured by Sanyo Chemical Industries Ltd.).

The acryl resin is a general term for polymers obtained by polymerizing at least an acryl monomer such as (meth)acrylic acid and (meth)acrylate as one component. Examples of the acryl resin include a resin obtained from an acryl monomer, and a copolymer of an acryl monomer and a monomer other than the acryl monomer. Examples of the acryl resin also include an acrylic-vinyl resin that is a copolymer of an acryl monomer and a vinyl monomer. Examples of the vinyl monomer include styrene.

As the acryl monomer, acrylamide, acrylonitrile, and the like can also be used. A commercially available product of a resin emulsion using the acryl resin as a raw material may be used. For example, a product selected from FK-854 (product name, manufactured by CHUORIKA KOUGYO Co., Ltd.), Mowinyl 952B and 718A (product names, manufactured by The Nippon Synthetic Chemical Industry Co., Ltd.), and Nipol LX852 and LX874 (product names, manufactured by Zeon Corporation) may be used.

The styrene-acryl resin is a copolymer obtained from a styrene monomer and a (meth)acryl monomer. Examples of the styrene-acryl resin include a styrene-acrylic acid copolymer, a styrene-methacrylic acid copolymer, a styrene-methacrylic acid-acrylate copolymer, a styrene-α-methylstyrene-acrylic acid copolymer, and a styrene-α-methylstyrene-acrylic acid-acrylate copolymer. A commercially available product of the styrene-acryl resin may be used. For example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (product names, manufactured by BASF), Mowinyl 966A and 975N (product names, manufactured by The Nippon Synthetic Chemical Industry Co., Ltd.), and VINYBLAN 2586 (manufactured by Nissin Chemical Industry Co., Ltd.) may be used.

The olefin resin is a polymer having olefin such as ethylene, propylene, and butylene in a structural skeleton. Well-known olefin resins can be appropriately selected for use. A commercially available product of the olefin resin can be used. For example, ARROWBASE CB-1200 and CD-1200 (product names, manufactured by Unitika Ltd.) may be used.

The resin particle is more preferably a urethane resin or an acryl resin and further preferably a urethane resin. In this case, rubbing fastness tends to be further enhanced.

A glass transition temperature (Tg) of the resin particle is preferably −60° C. or higher and 50° C. or lower, more preferably −60° C. or higher and 40° C. or lower, and further preferably −30° C. or higher and 10° C. or lower. When the glass transition temperature (Tg) of the resin particle is within this range, the property that follows the fabric (texture) tends to be further enhanced. For example, the glass transition temperature is measured in accordance with JIS K 7121 (Measurement Methods for Transition Temperatures of Plastics) using a differential scanning calorimeter “DSC 7000” manufactured by Hitachi High-Tech Science Corporation.

From a viewpoint of further enhancing rubbing fastness, a content of the resin particle is preferably 5.0% by mass or more, more preferably 7.0% by mass or more, further preferably 10.0% by mass or more, particularly preferably 12.0% by mass or more, and more particularly preferably 15.0% by mass or more with respect to a total amount of the textile printing clear ink jet ink composition.

From a viewpoint of further enhancing stability of continuous printing, the content of the resin particle is preferably 30.0% by mass or less, more preferably 25.0% by mass or less, further preferably 20.0% by mass or less, and particularly preferably 18.0% by mass or less with respect to the total amount of the textile printing clear ink jet ink composition.

When the content of the resin particle is within this range, particularly 7.0% by mass or more, rubbing fastness tends to be further enhanced, which is preferable.

### 1.2.2 Water

The textile printing clear ink jet ink composition contains the water. The same water as that of the above textile printing white ink jet ink composition can be used. The same applies to a content and the like thereof.

### 1.2.3 Organic Solvent

The textile printing clear ink jet ink composition may contain an organic solvent. The same organic solvent as that of the above textile printing white ink jet ink composition can be used. The same applies to a content and the like thereof.

### 1.2.4 Surfactant

The textile printing clear ink jet ink composition may contain a surfactant. The same surfactant as that of the above textile printing white ink jet ink composition can be used.

A content of the surfactant is preferably 8.0% by mass or less, more preferably 5.0% by mass or less, further preferably 3.0% by mass or less, particularly preferably 2.0% by mass or less, and more particularly preferably 1.5% by mass or less with respect to the total amount of the textile printing clear ink jet ink composition. When the content of the surfactant is within this range, the color developing property, rubbing fastness, and texture may be further enhanced.

A lower limit of the content of the surfactant is not particularly limited and is preferably 0.18 by mass or more, further preferably 0.3% by mass or more, more preferably 0.5% by mass or more, and further preferably 0.7% by mass or more with respect to the total amount of the textile printing clear ink jet ink composition.

### 1.2.5 Other Components

The textile printing clear ink jet ink composition may contain various additives such as a pH adjuster, a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the clear ink composition.

The textile printing clear ink jet ink composition may contain a coloring material such as a pigment. A content of the coloring material is preferably 0.2% by mass or less, more preferably 0.1% by mass or less, and further preferably 0.05% by mass or less with respect to the total amount of the textile printing clear ink jet ink composition, and a lower limit of the content is 0% by mass. The textile printing clear ink jet ink composition preferably does not contain a coloring material.

### 1.2.6 Physical Property

Viscosity and surface tension of the textile printing clear ink jet ink composition are preferably the same as those of the above textile printing white ink jet ink composition.

### 1.3 Treatment Liquid Composition

The composition set according to the present embodiment includes the treatment liquid composition containing the particle containing the organopolysiloxane and the water. Hereinafter, each component contained in the treatment liquid composition will be described.

### 1.3.1 Particle Containing Organopolysiloxane

The treatment liquid composition contains the particle containing the organopolysiloxane.

The “particle containing the organopolysiloxane” is not particularly limited as long as containing the organopolysiloxane. For example, a particle of the organopolysiloxane may be used, or a particle in a state where the organopolysiloxane is dispersed by an emulsifier or the like may be used.

The organopolysiloxane in the particle may have a property of solid or liquid. For example, when the organopolysiloxane in an oil form is dispersed in water in a particle form by an emulsifier, dispersed particles correspond to the particle containing the organopolysiloxane. Accordingly, an “emulsion particle containing a silicone oil” is included in the particle containing the organopolysiloxane.

Organopolysiloxane is a general term for organic silicone compounds having a siloxane bond “—Si(R¹R²)—O—” as a main skeleton and an organic group such as a methyl group, a phenyl group, a vinyl group, or an amino group bonded to the main skeleton as substituents R¹ and R². Organopolysiloxane has a property of an oil form, a rubber form, or a resin form depending on its chemical composition and molecular weight. The oil form, the rubber form, and the resin form may be referred to as a silicone oil, a silicone rubber, and a silicone resin, respectively. The organopolysiloxane is preferably a polymer compound.

The organopolysiloxane used in the treatment liquid composition according to the present embodiment is more preferably a compound in an oil form. When the organopolysiloxane is a compound in an oil form, the organopolysiloxane is likely to be stably dispersed in a particle form in an aqueous matrix through emulsification treatment described below.

A molecular structure of the organopolysiloxane is not particularly limited. Examples thereof include a linear form, a branching form, a cyclic form, a grid form, and a cage form. When the molecular structure of the organopolysiloxane is an acyclic structure, one or two or more groups selected from a hydrocarbon group, an alkoxy group, a hydroxyl group, a hydrogen atom, and halogen that may have a substituent are usually bonded to a terminal Si atom of the molecule.

The organopolysiloxane is not particularly limited. Examples thereof include dimethyl silicone, alkyl-modified silicone, amino-modified silicone, epoxy-modified silicone, cyclic silicone, and methyl phenyl silicone. These examples can be used alone, or two or more types of the examples can be used in combination.

The organopolysiloxane is preferably one type selected from dimethyl silicone, amino-modified silicone, and epoxy-modified silicone and more preferably dimethyl silicone among the examples. In particular, when the organopolysiloxane is dimethyl silicone, the color developing property and stability of continuous printing tend to be further enhanced.

The organopolysiloxane is preferably nonionic silicone. When the organopolysiloxane is nonionic silicone, the organopolysiloxane is less likely to agglomerate, and stability of continuous printing tends to be further enhanced. In particular, when the second treatment liquid composition, described later, is ejected using an ink jet method, stability of continuous printing tends to deteriorate because of agglomerating action of an agglomerating agent. Thus, the organopolysiloxane is preferably nonionic silicone. In addition, when the organopolysiloxane is nonionic silicone, the organopolysiloxane is chemically more stable, and yellowing or the like of a formed image is less likely to occur, which is preferable.

A commercially available silicone oil may be used as the organopolysiloxane. Examples thereof include a dimethyl silicone oil, a methyl phenyl silicone oil, a methyl hydrogen silicone oil, a polyether-modified silicone oil, an aralkyl-modified silicone oil, a fluoroalkyl-modified silicone oil, a long-chain alkyl-modified silicone oil, a higher fatty acid ester-modified silicone oil, a higher fatty acid amide-modified silicone oil, a polyether/long-chain alkyl/aralkyl-modified silicone oil, a long-chain alkyl/aralkyl-modified silicone oil, a phenyl-modified silicone oil, and a polyether/methoxy-modified silicone oil.

Examples of a commercially available product of the particle containing the organopolysiloxane include Highsofter (registered trademark) K-45 (manufactured by Meisei Chemical Works, Ltd., dimethyl silicone), POLON-MF-14 (manufactured by Shin-Etsu Chemical Co., Ltd., amine-modified silicone emulsion), and X-51-1264 (manufactured by Shin-Etsu Chemical Co., Ltd., epoxy-modified silicone emulsion).

For example, viscosity of the organopolysiloxane at 25° C. is not particularly limited and is preferably 1000 mPa·s or less, preferably 50 mPa·s or more, more preferably 500 mPa·s or more and 900 mPa's or less, and further preferably 600 mPa·s or more and 700 mPas or less. Base oil viscosity when the organopolysiloxane is emulsified and dispersed is not particularly limited. An upper limit thereof is preferably 1000000 mm²/s or less and more preferably 100000 mm²/s or less. A lower limit thereof is preferably 10 mm²/s or more and more preferably 10 mm²/s or more. The base oil viscosity indicates viscosity of a base oil and is a numerical value obtained by measuring a magnitude of internal resistance of the base oil. As the numerical value of the base oil viscosity increases, the viscosity of the base oil increases. As the numerical value of the base oil decreases, the viscosity of the base oil decreases.

As described above, the organopolysiloxane may be emulsified by an emulsifier and blended in a particle form. As the emulsifier, for example, a surfactant such as a nonionic surfactant, an anionic surfactant, a cationic surfactant, or an amphoteric surfactant can be used. The above surfactant that may be contained in the textile printing white ink jet ink composition may also be used.

A blending amount of the emulsifier when emulsifying the organopolysiloxane is not particularly limited and is preferably less than 20% by mass, more preferably 15% by mass or less, and particularly preferably 10% by mass or less with respect to a total amount of an emulsification composition.

An average particle diameter of the particle containing the organopolysiloxane is, for example, preferably 2 μm or less, more preferably 1 μm or less, and further preferably within a range of 0.2 to 0.8 μm.

From a viewpoint of further enhancing stability of continuous printing, a content of the particle containing the organopolysiloxane is preferably 30.0% by mass or less, more preferably 25.0% by mass or less, further preferably 20.0% by mass or less, still more preferably 17.0% by mass or less, particularly preferably 15.0% by mass or less, and more particularly preferably 14.0% by mass or less with respect to a total amount of the treatment liquid composition.

From a viewpoint of further enhancing rubbing fastness and texture, the content of the particle containing the organopolysiloxane is preferably 3.0% by mass or more, more preferably 5.0% by mass or more, further more preferably 7.0% by mass or more, particularly preferably 10.0% by mass or more, and more particularly preferably 12.08 by mass or more with respect to the total amount of the treatment liquid composition.

When the content of the particle containing the organopolysiloxane is preferably 5% to 15% by mass particularly with respect to the total amount of the treatment liquid composition, compatibility between both of rubbing fastness and texture tends to be favorably achieved, which is preferable.

The content of the particle containing the organopolysiloxane in the treatment liquid composition is preferably greater than the content of the resin particle in the above textile printing white ink jet ink composition. In this case, an effect of reducing the coefficient of friction on the surface of the textile-printed matter and improving smoothness and an effect of increasing flexibility of the ink coating by using the treatment liquid containing the particle containing the organopolysiloxane are effectively exhibited, and rubbing fastness and texture tend to be further enhanced.

More specifically, the content of the particle containing the organopolysiloxane in the treatment liquid composition is preferably 1.0 or more, more preferably 1.1 or more, further preferably 1.2 or more, and particularly preferably 1.3 or more with respect to the content of the resin particle in the above textile printing white ink jet ink composition. An upper limit is not particularly limited and is preferably 2.0 or less, more preferably 1.7 or less, and further preferably 1.5 or less.

The content of the particle containing the organopolysiloxane in the treatment liquid composition is preferably less than the content of the resin particle in the textile printing clear ink jet ink composition. In this case, an effect of reducing the coefficient of friction on the surface of the textile-printed matter and improving smoothness and an effect of increasing flexibility of the ink coating by using the treatment liquid containing the particle containing the organopolysiloxane are effectively exhibited, and rubbing fastness and texture tend to be further enhanced.

More specifically, the content of the particle containing the organopolysiloxane in the treatment liquid composition is preferably 0.95 or less, more preferably 0.90 or less, and further preferably 0.88 or less with respect to the content of the resin particle in the above textile printing clear ink jet ink composition. A lower limit is not particularly limited and is preferably 0.50 or more, more preferably 0.70 or more, and further preferably 0.80 or more.

Meanwhile, the content of the particle containing the organopolysiloxane is preferably 90.0% by mass or more with respect to a total solid content in the treatment liquid composition. That is, 90.0% by mass or more of the solid content that remains when the treatment liquid composition is dried is preferably the organopolysiloxane. The content of the particle containing the organopolysiloxane is more preferably 95.0% by mass or more, further preferably 98% by mass or more, and particularly preferably 99.0% by mass or more with respect to the total solid content in the treatment liquid composition.

When the content of the particle containing the organopolysiloxane is 90% by mass or more with respect to the total solid content in the treatment liquid composition, a coating having a sufficiently lower refractive index is likely to be formed, and an image having a more favorable color developing property tends to be formed. In addition, more favorable stability of ejection when the treatment liquid composition is ejected using the ink jet method tends to be achieved.

### 1.3.2 Water

The treatment liquid composition contains the water. The same water as that of the above textile printing white ink jet ink composition can be used.

A content of the water is preferably 40% by mass or more, further preferably 50% by mass or more, more preferably 60% by mass or more, and particularly preferably 70% by mass or more with respect to the total amount of the treatment liquid composition. An upper limit of the content of the water is not particularly limited and is, for example, preferably 90% by mass or less, further preferably 95% by mass or less, and more preferably 90% by mass or less with respect to the total amount of the textile printing white ink jet ink composition.

### 1.3.3 Organic Solvent

The treatment liquid composition may contain an organic solvent. The same organic solvent as that of the above textile printing white ink jet ink composition can be used.

In the treatment liquid composition, the organic solvent preferably contains an organic solvent having a standard boiling point greater than 280° C. and more preferably contains an organic solvent having a standard boiling point of 290° C. or higher. Examples of the organic solvent having a standard boiling point of 290° C. or higher include glycerin.

The content of the organic solvent is preferably 1% to 30% by mass, more preferably 3% to 20% by mass, further preferably 5% to 15% by mass, and particularly preferably 6% to 10% by mass with respect to the total amount of the treatment liquid composition. When the content of the organic solvent is within this range, the color developing property, rubbing fastness, and texture may be further enhanced. The content of the organic solvent having a standard boiling point of 290° C. or higher is also preferably within this range.

### 1.3.4 Other Components

The treatment liquid composition may contain various additives such as a surfactant, a resin particle, a pH adjuster, a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the treatment liquid composition.

The treatment liquid composition may contain a coloring material such as a pigment. A content of the coloring material is preferably 0.2% by mass or less, more preferably 0.1% by mass or less, and further preferably 0.05% by mass or less with respect to the total amount of the treatment liquid composition, and a lower limit of the content is 0% by mass. The treatment liquid composition preferably does not contain a coloring material.

### 1.3.5 Physical Property

Viscosity and surface tension of the treatment liquid composition are preferably the same as those of the above textile printing white ink jet ink composition.

### 1.3.6 Application

The treatment liquid composition may be ejected and used by the ink jet method. In this case, a predetermined application amount of the treatment liquid composition is likely to be applied to a predetermined region, and the treatment liquid composition can be efficiently applied, which is preferable.

### 1.4 Second Treatment Liquid Composition

The composition set according to the present embodiment may further include the second treatment liquid composition containing an agglomerating agent for agglomerating a component in the ink, and water. Accordingly, a more favorable color developing property tends to be achieved.

### 1.4.1 Agglomerating Agent

The second treatment liquid composition contains the agglomerating agent. The agglomerating agent reacts with a component such as the pigment and the resin particle and acts to agglomerate the component in the ink. For example, this agglomeration enables an increase in a color developing property of the pigment, an increase in fixability of the resin particle, and/or an increase in viscosity of the ink. A degree of agglomeration of the pigment or the resin particle by the agglomerating agent varies depending on a type of each of the agglomerating agent, the color pigment, and the resin particle and can be adjusted.

The agglomerating agent is not particularly limited. Examples thereof include a metal salt, an inorganic acid, an organic acid, and a cationic compound. As the cationic compound, a cationic resin (cationic polymer), a cationic surfactant, and the like can be used. Among the examples, a polyvalent metal salt is preferably used as the metal salt, and the cationic resin is preferably used as the cationic compound.

Thus, the agglomerating agent selected from the polyvalent metal salt, the organic acid, and the cationic resin is preferably used in terms of particularly enhancing the achieved color developing property and the like.

The polyvalent metal salt is a compound configured with a divalent or higher valent metal ion and an anion. Examples of the divalent or higher valent metal ion include calcium, magnesium, copper, nickel, zinc, barium, aluminum, titanium, strontium, chromium, cobalt, and iron ions. Among the metal ions constituting the polyvalent metal salt, at least one of the calcium ion and the magnesium ion is preferably used in terms of enhancing a property of agglomerating the ink component.

The anion constituting the polyvalent metal salt is an inorganic ion or an organic ion. That is, the polyvalent metal salt in the present disclosure consists of an inorganic ion or an organic ion and a polyvalent metal. Examples of the inorganic ion include a chloride ion, a bromine ion, an iodine ion, a nitrate ion, a sulfate ion, and a hydroxide ion. Examples of the organic ion include an organic acid ion. Examples of the organic acid ion include a carboxylic acid ion.

A polyvalent metal compound is preferably an ionic polyvalent metal salt. In particular, when the polyvalent metal salt is a magnesium salt or a calcium salt, more favorable stability of the treatment liquid is achieved. Any of an inorganic acid ion and an organic acid ion may be used as a counterion of the polyvalent metal.

Specific examples of the polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium formate, calcium acetate, magnesium acetate, and aluminum acetate. One type of the polyvalent metal salt may be used alone, or two or more types of the polyvalent metal salts may be used in combination. Among the examples, at least any of calcium formate, magnesium sulfate, calcium nitrate, and calcium chloride is preferably used, and calcium formate or calcium nitrate is more preferably used because sufficient solubility in water can be secured, and traces of the treatment liquid are reduced (traces are not noticeable). These metal salts may have water of hydration in a raw material form.

Examples of a metal salt other than the polyvalent metal salt include a monovalent metal salt such as a sodium salt and a potassium salt. Examples of the monovalent metal salts include sodium sulfate and potassium sulfate.

Preferable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyrone carboxylic acid, pyrrole carboxylic acid, furancarboxylic acid, pyridine carboxylic acid, coumaric acid, thiophene carboxylic acid, nicotinic acid, derivatives of compounds thereof, and salts thereof. One type of the organic acid may be used alone, or two or more types of the organic acid may be used in combination. The above metal salt includes a metal salt that is a salt of the organic acid.

Examples of the inorganic acid include sulfuric acid, hydrochloric acid, nitric acid, and phosphoric acid. One type of the inorganic acid may be used alone, or two or more types of the inorganic acid may be used in combination.

The cationic resin is a resin having a cationic group. Examples of the resin include a urethane-based resin, an acrylic resin, a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, and an ethylene vinyl acetate-based resin. Among the examples, a urethane resin, an acrylic resin, and a polyolefin-based resin are preferably used.

Examples of the cationic group include an amino group, an ammonium group, an amide group, and a hydration group. The amino group includes a primary amine group, a secondary amine group, and a tertiary amine group. The resin may include one type or two or more types of the cationic group.

Examples of the resin including the primary amine group include polyallylamine, polyallylamine hydrochloride, polyallylamineamide sulfate, a methoxycarbonylated allylamine polymer, a methylcarbonylated allylamine acetate polymer, a ureated polyallylamine polymer, a carboxylmethylated polyallylamine polymer, and a hexamethylenediamine/epichlorohydrin resin.

Examples of the resin including the secondary amine group include a diallylamine polymer, a diallylamine hydrochloride polymer, a diallylamine hydrochloride/sulfur dioxide copolymer, a diallylamine acetate/sulfur dioxide copolymer, a diallylamine hydrochloride/acrylamide copolymer, a dimethylamine/epichlorohydrin resin, a dimethylamine/ammonia/epichlorohydrin resin, and a dimethylamine/ethylenediamine/epichlorohydrin polymer.

Examples of the resin including the tertiary amine group include a methyldiallylamine hydrochloride polymer, a methyldiallylamineamide sulfate polymer, a methyldialylamine acetate polymer, a methyldiallylamine hydrochloride/sulfur dioxide copolymer, and a dicyandiamide/polyalkylene polyamine polycondensate.

Examples of the resin including the ammonium group include a resin including a quaternary ammonium base. Examples of the resin include a diallyldimethylammonium chloride polymer, a diallylmethylethylammonium ethylsulfate polymer, a diallylmethylethylammonium ethylsulfate/sulfur dioxide copolymer, a diallyldimethylammonium chloride/sulfur dioxide copolymer, and a diallyldimethylammonium chloride/acrylamide copolymer.

Examples of the resin including the amide group include polyamide and a polyamide epoxy resin.

Examples of the cationic surfactant include primary, secondary, and tertiary amine salt compounds, an alkylamine salt, a dialkylamine salt, an aliphatic amine salt, a benzalconium salt, a quaternary ammonium salt, a quaternary alkylammonium salt, an alkylpyridinium salt, a sulfonium salt, a phosphonium salt, an onium salt, and an imidazolinium salt. Specific examples of the cationic surfactant include hydrochloride such as laurylamine, cocoamine, and rosinamine, acetate, lauryltrimethylammonium chloride, cetyltrimethylammonium chloride, benzyltributylammonium chloride, benzalkonium chloride, dimethylethyllaurylammonium ethyl sulfate, dimethylethyloctyl ammonium ethyl sulfate, trimethyl lauryl ammonium hydrochloride, cetyl pyridinium chloride, cetyl pyridinium bromide, dihydroxyethyl lauryl amine, decyl dimethyl benzyl ammonium chloride, dodecyl dimethyl benzyl ammonium chloride, tetradecyl dimethyl ammonium chloride, hexa decyl dimethyl ammonium chloride, and octa decyl dimethyl ammonium chloride.

A plurality of types of the agglomerating agents may be used. When at least one type of the polyvalent metal salt, the organic acid, and the cationic resin is selected from the agglomerating agents, more favorable agglomerating action is achieved. Thus, an image having higher image quality (in particular, a favorable color developing property) can be formed.

More preferably, the agglomerating agent contained in the second treatment liquid composition is the polyvalent metal salt. The agglomerating action of the polyvalent metal salt is particularly strong. Thus, a more favorable color developing property tends to be achieved. Meanwhile, when the polyvalent metal salt is used, rubbing fastness is likely to deteriorate. Meanwhile, the composition set according to the present embodiment tends to achieve a more favorable color developing property while maintaining favorable rubbing fastness.

From a viewpoint of further enhancing the color developing property, a content of the agglomerating agent is preferably 1.0% by mass or more, more preferably 2.0% by mass or more, further preferably 3.0% by mass or more, particularly preferably 3.5% by mass or more, and more particularly preferably 4.0% by mass or more with respect to a total amount of the second treatment liquid composition.

From a viewpoint of further enhancing rubbing fastness, the content of the agglomerating agent is preferably 15.0% by mass or less, more preferably 12.0% by mass or less, further preferably 10.0% by mass or less, particularly preferably 8.5% by mass or less, and more particularly preferably 7.0% by mass or less with respect to the total amount of the second treatment liquid composition.

In particular, the content of the agglomerating agent is preferably 3.5% to 8.5% by mass with respect to the total amount of the second treatment liquid composition. When the content is within this range, the color developing property and rubbing fastness tend to be further enhanced.

### 1.4.2 Water

The second treatment liquid composition contains the water. The same water as that of the above textile printing white ink jet ink composition can be used.

A content of the water is preferably 40% by mass or more, further preferably 50% by mass or more, more preferably 60% by mass or more, and particularly preferably 70% by mass or more with respect to the total amount of the second treatment liquid composition. An upper limit of the content of the water is not particularly limited and is, for example, preferably 90% by mass or less and further preferably 85% by mass or less with respect to the total amount of the second treatment liquid composition.

### 1.4.3 Organic Solvent

The second treatment liquid composition may contain an organic solvent. The same organic solvent as that of the above textile printing white ink jet ink composition can be used.

The organic solvent in the second treatment liquid composition preferably contains polyhydric alcohols, more preferably contains one or more selected from alkanediols and polyols, and further preferably contains one or more selected from 1,2-alkanediol and a compound including three or more hydroxyl groups. When the organic solvent contains these solvents, the color developing property, rubbing fastness, and texture may be further enhanced.

The organic solvent preferably contains an organic solvent having a standard boiling point greater than 280° C. When the organic solvent contains an organic solvent having a standard boiling point greater than 280° C., the color developing property, rubbing fastness, and texture may be further enhanced. Examples of the organic solvent having a standard boiling point greater than 280° C. include triethylene glycol and glycerin.

The content of the organic solvent is preferably 5% to 50% by mass, more preferably 8% to 40% by mass, further preferably 10% to 30% by mass, and particularly preferably 13% to 24% by mass with respect to the total amount of the second treatment liquid composition. When the content of the organic solvent is within this range, the color developing property, rubbing fastness, and texture may be further enhanced.

The content of the organic solvent having a standard boiling point greater than 280° C. is preferably 3% to 30% by mass, more preferably 5% to 25% by mass, further preferably 5% to 20% by mass, and particularly preferably 6% to 14% by mass with respect to the total amount of the second treatment liquid composition.

### 1.4.4 Surfactant

The second treatment liquid composition may contain a surfactant. The same surfactant as that of the above textile printing white ink jet ink composition can be used. The same applies to a content and the like thereof.

### 1.4.5 Other Components

The second treatment liquid composition may contain various additives such as a resin particle, a pH adjuster, a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the treatment liquid composition.

### 1.4.6 Physical Property

Viscosity and surface tension of the second treatment liquid composition are preferably the same as those of the above textile printing white ink jet ink composition.

### 1.4.7 Application

The second treatment liquid composition may be ejected and used by the ink jet method. In this case, a predetermined application amount of the second treatment liquid composition is likely to be applied to a predetermined region, and the second treatment liquid composition can be efficiently applied, which is preferable.

### 2. Ink Jet Recording Method

An ink jet recording method according to an embodiment of the present disclosure is an ink jet recording method performed using the above composition set and includes a white ink jet ink application step of applying the textile printing white ink jet ink composition to the fabric using the ink jet method, a treatment liquid application step of applying the treatment liquid composition to a region of the fabric to which the textile printing white ink jet ink composition is applied, and a clear ink application step of applying the textile printing clear ink jet ink composition to the region of the fabric to which the textile printing white ink jet ink composition is applied.

The ink jet recording method according to the present embodiment is performed using the above composition set and thus, can achieve a favorable color developing property and texture while achieving more favorable rubbing fastness.

Hereinafter, each step of the ink jet recording method according to the present embodiment will be described.

### 2.1 White Ink Jet Ink Application Step

The ink jet recording method according to the present embodiment includes the white ink jet ink application step of applying the above textile printing white ink jet ink composition to the fabric using the ink jet method.

### 2.1.1 Application Amount

In the white ink jet ink application step, an application amount of the textile printing white ink jet ink composition per unit area of the fabric is preferably 30 mL/m² or more, more preferably 50 mL/m² or more, further preferably 70 mL/m² or more, and particularly preferably 90 mL/m² or more from a viewpoint of further enhancing the color developing property.

In the white ink jet ink application step, the application amount of the textile printing white ink jet ink composition per unit area of the fabric is preferably 150 mL/m² or less, more preferably 130 mL/m² or less, further preferably 110 mL/m² or less, and particularly preferably 100 mL/m² or less from a viewpoint of further enhancing texture and rubbing fastness.

### 2.1.2 Order of Application

In the ink jet recording method according to the present embodiment, an order in which the white ink jet ink application step is performed is not particularly limited as long as the treatment liquid application step, described later, of applying the treatment liquid composition to the region of the fabric to which the textile printing white ink jet ink composition is applied can be performed, and the clear ink application step, described later, of applying the textile printing clear ink jet ink composition to the region of the fabric to which the textile printing white ink jet ink composition is applied can be performed. For example, the white ink jet ink application step is preferably performed before the treatment liquid application step and the clear ink application step.

### 2.1.3 Fabric

Examples of a material of the fabric used in the ink jet recording method according to the present embodiment include a natural fiber such as cotton, hemp, wool, and silk, a synthetic fiber such as polypropylene, polyester, acetate, triacetate, polyamide, and polyurethane, and a biodegradable fiber such as polylactic acid, and a blended fiber thereof may also be used. Among these materials, cotton, polyester, or a blend of cotton and polyester is readily available as the fabric, which is preferable.

Examples of a form of the fabric include a cloth, clothes, and other accessories. The cloth includes a woven fabric, a knitted fabric, a nonwoven fabric, and the like. The clothes and other accessories include a T-shirt, a handkerchief, a scarf, a towel, and a handbag after sewing, types of furniture such as a bag, a curtain, a sheet, a bedspread, and a wallpaper made of cloth, and a cloth before and after cutting as a part before sewing. Examples of these forms include a long roll-shaped form, a form cut in a predetermined size, and a form having a shape of a product.

A value of lightness L* of the fabric in the L*a*b* color space is preferably 70 or less. The value of L* may be 60 or less or 50 or less.

The value of L* can be measured using a well-known colorimeter. For example, the value of L* can be measured using Spectrolino (manufactured by GretagMacbeth).

Examples of the fabric of which the value of L* is 70 or less include a colored fabric colored in advance with a dye or the like, and a black fabric is preferably used. Examples of the dye with which the fabric is colored in advance include a water-soluble dye such as an acidic dye and a basic dye, a disperse dye used in combination with a dispersant (a surfactant), and a reactive dye. As a method of coloring the fabric with the dye, a well-known method can be adopted depending on the material forming the fabric and the form and the like of the fabric.

The fabric used in the ink jet recording method according to the present embodiment is preferably a colored cotton fabric. When such a fabric is used, more favorable rubbing fastness and a more favorable color developing property in a white portion tend to be achieved.

### 2.2 Treatment Liquid Application Step

The ink jet recording method according to the present embodiment includes the treatment liquid application step of applying the above treatment liquid composition to the region of the fabric to which the textile printing white ink jet ink composition is applied.

### 2.2.1 Application Method

An application method of the treatment liquid composition in the treatment liquid application step is not particularly limited. Examples thereof include an immersion application method of immersing the fabric in the treatment liquid composition, a roller application method of applying the treatment liquid composition using a mangle roller, a roll coater, or the like, a spray application method of ejecting the treatment liquid composition using a spray apparatus or the like, and an ink jet application method of ejecting the treatment liquid composition using the ink jet method.

The treatment liquid application step is preferably performed using a method that enables the treatment liquid composition to be applied to only the region to which the textile printing white ink jet ink composition is applied, and particularly preferably using the ink jet method. When the treatment liquid application step is performed using the ink jet method, an application region and an application amount can be precisely controlled. Thus, a necessary and sufficient amount of the treatment liquid composition can be evenly applied to the region to which the textile printing white ink jet ink composition is applied, and rubbing fastness and texture tend to be further enhanced.

### 2.2.2 Application Amount

In the treatment liquid application step, an application amount of the treatment liquid composition per unit area of the fabric is preferably 3 mL/m² or more, more preferably 5 mL/m² or more, further preferably 7 mL/m² or more, and particularly preferably 10 mL/m² or more from a viewpoint of further enhancing rubbing fastness and texture.

In the treatment liquid application step, the application amount of the treatment liquid composition per unit area of the fabric is preferably 30 mL/m² or less, more preferably 25 mL/m² or less, further preferably 20 mL/m² or less, and particularly preferably 15 mL/m² or less from a viewpoint of further enhancing rubbing fastness and texture.

### 2.2.3 Order of Application

In the ink jet recording method according to the present embodiment, an order in which the treatment liquid application step is performed is not particularly limited as long as the treatment liquid composition is applied to the region of the fabric to which the textile printing white ink jet ink composition is applied. For example, the treatment liquid application step may be performed before, after, or simultaneously with the clear ink application step described later.

In the ink jet recording method according to the present embodiment, the treatment liquid application step is preferably performed simultaneously with the clear ink application step. By applying the treatment liquid composition and the textile printing clear ink jet ink composition at the same time, the particle containing the organopolysiloxane is more favorably dispersed in the ink coating, and flexibility of the coating is increased. More favorable texture tends to be achieved.

When the treatment liquid application step and the clear ink application step are performed at the same time, the treatment liquid application step and the clear ink application step are preferably performed by applying the treatment liquid composition and the textile printing clear ink jet ink composition to the same region of the fabric in the same scanning.

Here, “scanning” means moving the ink jet head relative to a recording region on the fabric. In this case, scanning may be performed by moving the ink jet head with respect to the fabric or by moving the fabric with respect to the ink jet head. Alternatively, a relative positional relationship between both of the ink jet head and the fabric may be changed by moving positions of both of the ink jet head and the fabric.

The ink jet head can be mounted on, for example, a carriage. The ink jet head may be moved by moving the carriage. That is, even in this case, the ink jet head moves.

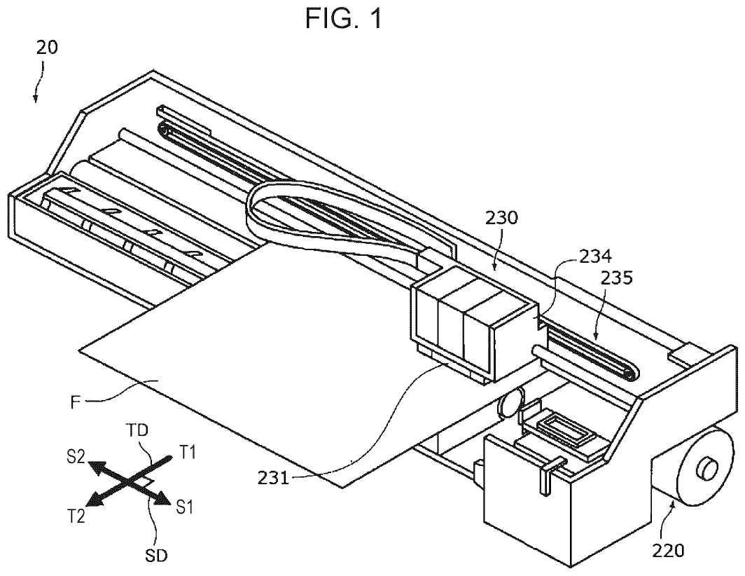

Accordingly, for example, in an ink jet recording apparatus 20 of a serial type shown in FIG. 1, “scanning” is performed by performing recording while moving a carriage 234 including an ink jet head 231 in a scanning direction SD intersecting with a transport direction TD of a recording medium F.

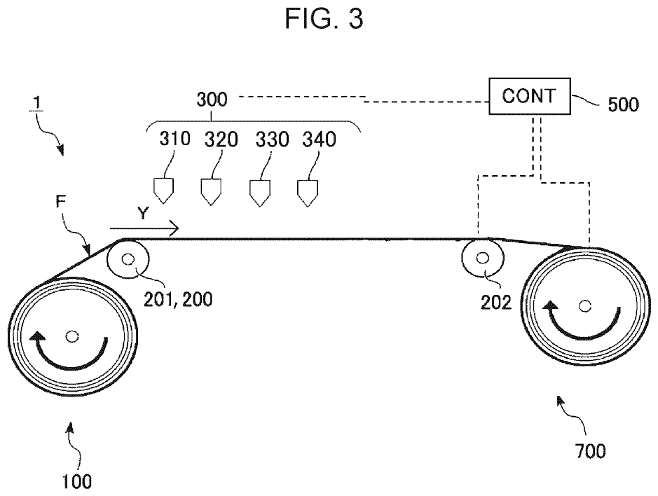

For example, in an ink jet recording apparatus 1 of a line type shown in FIG. 3, “scanning” is performed by performing recording while moving a position of the recording medium F relative to a line head 300 having a length corresponding to a width of the recording medium F, in a direction intersecting with a direction of the width. In recording of the line type, the ink jet head (line head) does not move and is fixed during recording, and recording is performed in a single scanning.

The “length corresponding to the width of the recording medium” is not limited to a length when the width of the recording medium and the length (width) of the line head completely match, and may be a length greater than or equal to the length corresponding to the width of the recording medium or a length corresponding to a width (recording width) of the recording medium in which the ink is to be ejected (an image is to be recorded).

A difference in time between application of the treatment liquid composition and application of the textile printing clear ink jet ink composition in the same region of the fabric is preferably within 30 seconds, more preferably within 15 seconds, further preferably within 5 seconds, still more preferably within 1 second, particularly preferably within 0.5 seconds, and more particularly preferably within 0.1 seconds. When the difference in time is in this range, both liquids favorably mix with each other, and texture tends to be further enhanced.

### 2.3 Clear Ink Application Step

The ink jet recording method according to the present embodiment includes the clear ink application step of applying the above textile printing clear ink jet ink composition to the region of the fabric to which the textile printing white ink jet ink composition is applied.

### 2.3.1 Application Amount

In the clear ink application step, an application amount of the textile printing clear ink jet ink composition per unit area of the fabric is preferably 6 mL/m² or more, more preferably 10 mL/m² or more, further preferably 15 mL/m² or more, and particularly preferably 20 mL/m² or more from a viewpoint of further enhancing rubbing fastness.

In the clear ink application step, the application amount of the textile printing clear ink jet ink composition per unit area of the fabric is preferably 60 mL/m² or less, more preferably 50 mL/m² or less, further preferably 40 mL/m² or less, and particularly preferably 30 mL/m² or less from a viewpoint of further enhancing rubbing fastness and texture.

### 2.3.2 Order of Application

In the ink jet recording method according to the present embodiment, an order in which the clear ink application step is performed is not particularly limited as long as the textile printing clear ink jet ink composition is applied to the region of the fabric to which the textile printing white ink jet ink composition is applied. For example, the clear ink application step may be performed before, after, or simultaneously with the treatment liquid application step. An aspect of performing the clear ink application step simultaneously with the treatment liquid application step is described above.

2.4 Second Treatment Liquid Application step

The ink jet recording method according to the present embodiment may further include a second treatment liquid application step of applying the above second treatment liquid composition to the fabric.

### 2.4.1 Application Method

An application method of the second treatment liquid composition in the second treatment liquid application step is not particularly limited and can be the same as that of the above treatment liquid application step. The second treatment liquid application step is preferably performed using a method that enables the second treatment liquid composition to be applied to only the region to which the textile printing white ink jet ink composition is applied, and particularly preferably using the ink jet method. When the second treatment liquid application step is performed using the ink jet method, an application region and an application amount can be precisely controlled. Thus, a necessary and sufficient amount of the second treatment liquid composition can be evenly applied to the region to which the textile printing white ink jet ink composition is applied, and rubbing fastness and texture tend to be further enhanced.

### 2.4.2 Application Amount

In the second treatment liquid application step, an application amount of the second treatment liquid composition per unit area of the fabric is preferably 6 mL/m² or more, more preferably 10 mL/m² or more, further preferably 15 mL/m² or more, and particularly preferably 20 mL/m² or more from a viewpoint of further enhancing the color developing property.

In the second treatment liquid application step, the application amount of the second treatment liquid composition per unit area of the fabric is preferably 60 mL/m² or less, more preferably 50 mL/m² or less, further preferably 40 mL/m² or less, and particularly preferably 30 mL/m² or less from a viewpoint of further enhancing rubbing fastness and texture.

### 2.4.3 Order of Application

When the second treatment liquid composition is applied using the immersion application method, the roller application method, or the like, the second treatment liquid application step is preferably performed in advance on the fabric and is preferably performed before the white ink jet ink application step.

When the second treatment liquid composition is applied using the ink jet method, the second treatment liquid application step is preferably performed before or simultaneously with the white ink jet ink application step.

In particular, when the second treatment liquid application step based on the ink jet method is performed simultaneously with the white ink jet ink application step, more favorable texture tends to be achieved.

When the second treatment liquid application step and the white ink jet ink application step are performed at the same time, the second treatment liquid application step and the white ink jet ink application step are preferably performed by applying the second treatment liquid composition and the textile printing white ink jet ink composition to the same region of the fabric in the same scanning.

A difference in time between application of the second treatment liquid composition and application of the textile printing white ink jet ink composition in the same region of the fabric can be the same as the above difference in time between application of the treatment liquid composition and application of the textile printing clear ink jet ink composition in the same region of the fabric.

### 2.5 Drying Step

The ink jet recording method according to the present embodiment may have a drying step of drying the fabric by heating the fabric at 160° C. or higher after the treatment liquid application step and the clear ink application step described above. By including such a drying step, more favorable rubbing fastness tends to be achieved.

A drying method in the drying step is not particularly limited. Examples thereof include a heat press, a belt conveyor oven, an atmospheric pressure steam method, a high pressure steam method, a thermofix method, and blowing. A heat source for drying is not particularly limited. For example, an infrared lamp can be used.

A drying temperature is preferably a temperature at which the resin particle that may be included in the ink is fused to evaporate a medium such as moisture. The drying temperature is 160° C. or higher. Meanwhile, the drying temperature may be 100° C. or higher and 250° C. or lower, 120° C. or higher and 230° C. or lower, 150° C. or higher and 200° C. or lower, or 160° C. or higher and 180° C. or lower. Here, the drying temperature in the drying step means a surface temperature of the image or the like formed on the fabric.

A duration of drying is not particularly limited and is, for example, preferably 10 seconds or more and 10 minutes or less, more preferably 20 seconds or more and 5 minutes or less, and further preferably 60 seconds or more and 3 minutes or less.

The drying step may be performed while applying a pressure using the heat press or the like. The pressure to be applied is not particularly limited and is preferably 1 to 10 N/cm², more preferably 1 to 8 N/cm², and further preferably 1 to 5 N/cm².

### 2.6 Other Steps

The ink jet recording method according to the present embodiment may include rinsing the fabric on which recording is performed, performing heating and drying again, and the like. In rinsing, components such as the ink not fixed on the fabric may be washed out using a hot soap liquid or the like, as necessary, as soaping treatment.

### 2.7 Ink Jet Recording Apparatus

The ink jet recording apparatus that can be preferably used for the ink jet recording method according to the present embodiment will be described.

As an example of the ink jet recording apparatus, FIG. 1 shows a perspective view of a serial printer. As shown in FIG. 1, a serial printer 20 includes a transport portion 220 and a recording portion 230. The transport portion 220 transports the recording medium F fed to the serial printer to the recording portion 230, and the recording medium after recording is discharged outside the serial printer. Specifically, the transport portion 220 includes each feeding roller and transports the fed recording medium F in the transport direction TD.

The recording portion 230 includes the carriage 234 on which the ink jet head 231 including a nozzle for ejecting the above textile printing white ink jet ink composition, a nozzle for ejecting the above textile printing clear ink jet ink composition, a nozzle for ejecting the above treatment liquid composition, and a nozzle for ejecting the above second treatment liquid composition, as necessary, to the recording medium F fed from the transport portion 220 is mounted, and a carriage moving mechanism 235 for moving the carriage 234 in the scanning direction SD of the recording medium F.

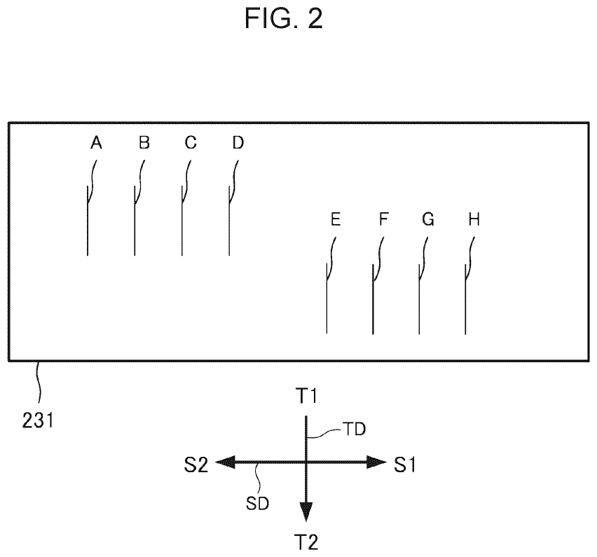

FIG. 2 shows an example of each nozzle array provided on a nozzle surface of the ink jet head 231. In FIG. 2, the ink jet head 231 includes a plurality of nozzle arrays, that is, arrays A to H along the scanning direction SD, each consisting of a plurality of nozzles arranged along a direction (the transport direction TD) intersecting with a direction (the scanning direction SD) in which the ink jet head 231 is moved.

By disposing a nozzle array for ejecting the treatment liquid composition to at least partially overlap with a nozzle array for ejecting the textile printing clear ink jet ink composition in the transport direction TD when projected along the scanning direction SD, the treatment liquid composition and the textile printing clear ink jet ink composition can be applied to the same region of the fabric in the same scanning. In the same manner, the second treatment liquid composition and the textile printing white ink jet ink composition can be applied to the same region of the fabric in the same scanning.

The ink and the like to be ejected from each nozzle array are appropriately selected. For example, the arrays A and B are preferably selected as a nozzle array for ejecting the second treatment liquid composition. The arrays C and D are preferably selected as a nozzle array for ejecting the textile printing white ink jet ink composition. The arrays E and F are preferably selected as a nozzle array for ejecting the textile printing clear ink jet ink composition. The arrays G and H are preferably selected as a nozzle array for ejecting the treatment liquid composition.

When the serial printer is used, a head having a length less than the width of the recording medium is provided as the ink jet head 231, and recording is performed while the head moves in the scanning direction SD intersecting with the transport direction TD of the recording medium F. In the serial printer, the head 231 is mounted on the carriage 234 that moves in a predetermined direction, and the ink compositions, the treatment liquid composition, and, as necessary, the second treatment liquid composition are ejected to the recording medium by moving the head in accordance with movement of the carriage. The recording medium may be transported between each scanning.

The ink jet recording apparatus is not limited to the printer of the serial type and may be a printer of the line type. FIG. 3 shows a schematic side view of a line printer as another example of the ink jet recording apparatus. As shown in FIG. 3, a line printer 1 includes a feeding portion 100, a transport mechanism 200 for transporting the recording medium in the transport direction, the line head 300 that ejects the ink to apply the ink to the recording medium, a control portion 500, and a discharge portion 700.

The transport mechanism is a mechanism for transporting the recording medium in the transport direction. In FIG. 3, the roll-shaped recording medium F is supplied from the feeding portion 100 to the transport mechanism 200, and the transport mechanism 200 is configured to transport the recording medium F fed from the feeding portion 100 to the line head 300. Specifically, the transport mechanism 200 includes a first feeding roller 201 and a second feeding roller 202 and is configured to transport the fed recording medium F to the line head 300 downstream in the transport direction. As a transport method of the transport mechanism 200, a well-known method in the related art can be appropriately used, or one or a plurality of rollers, a belt fed by a roller, or the like may be used.

The line printer 1 includes the line head 300 having a length corresponding to the width of the recording medium F. The line head 300 may be configured with a plurality of line jets. In FIG. 3, the line head 300 is configured with a first line head 310, a second line head 320, a third line head 330, and a fourth line head 340. The first line head 310, the second line head 320, the third line head 330, and the fourth line head 340 will be simply referred to as the line head 300 unless necessary to distinguish therebetween.

The line head 300 has cavities for accommodating the treatment liquid composition, the textile printing clear ink jet ink composition, the textile printing white ink jet ink composition, and, as necessary, the second treatment liquid composition (the ink and the like), an ejection driving portion provided for each cavity, and nozzles for ejecting the ink and the like. A plurality of cavities and a plurality of ejection driving portions and nozzles provided for each cavity may be provided in one head independently of each other. The ejection driving portion can be formed using an electromechanical conversion element such as a piezoelectric element that mechanically deforms to change a volume of the cavities, an electronic heat conversion element that emits heat to generate an air bubble in the ink and eject the ink, or the like.

For example, the line head 300 is preferably configured to eject two treatment liquid compositions from the first line head 310 and eject the textile printing white ink jet ink composition from the second line head 320. By doing so, the reactive liquid and the clear ink composition can be applied to the same region of the fabric in the same scanning. It is preferable to eject the textile printing clear ink jet ink composition from the third line head 330 and eject the treatment liquid composition from the fourth line head 340.

In the line printer, the head is fixed and (substantially) does not move, and recording is performed in a single scanning of the ink jet head. The line printer is more advantageous than the serial printer in terms of a high recording speed.

### 3. Example

Hereinafter, the present disclosure will be more specifically described with reference to examples. It should be noted that the present disclosure is not limited to those examples. Unless otherwise specified, “%” below is based on mass.

### 3.1 Preparation of Each Ink Composition and Each Treatment Liquid Composition

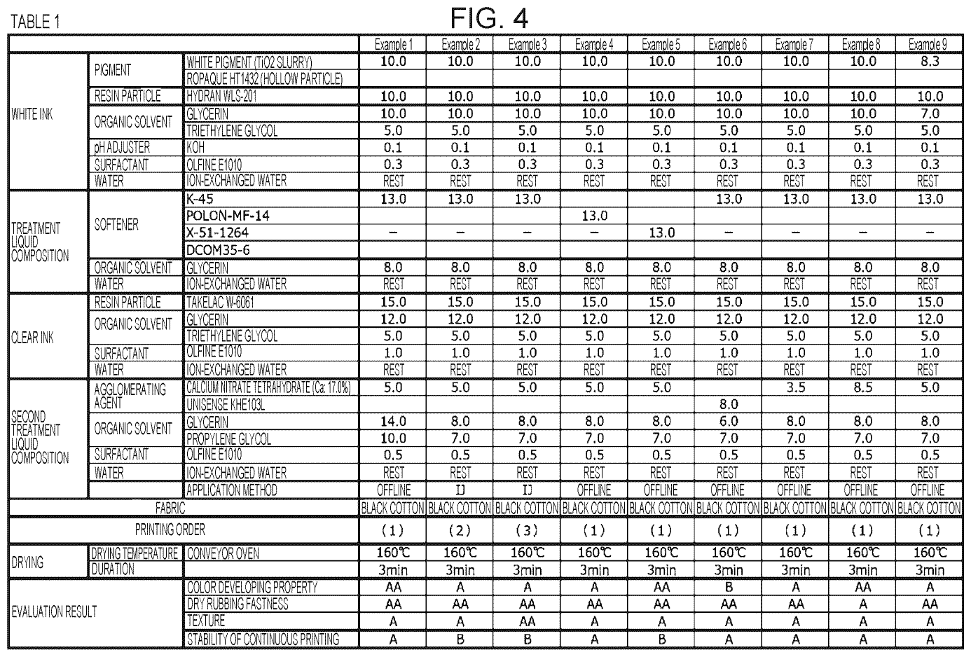

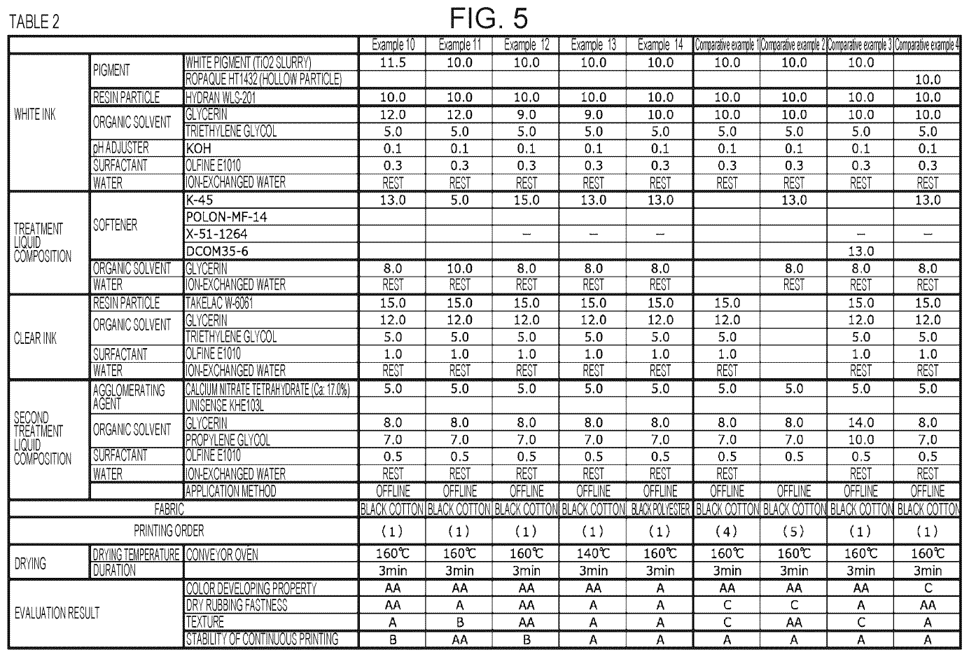

Each component is put into a container to obtain the composition in Table 1 (FIG. 4) and Table 2 (FIG. 5) and is mixed, stirred, and then filtered through a 5-μm membrane filter to obtain the textile printing white ink jet ink composition (white ink), the textile printing clear ink jet ink composition (clear ink), the treatment liquid composition, and the second treatment liquid composition of each example. Unless otherwise specified, numerical values of each component shown in each example in the table indicate % by mass. The % by mass of the pigment, the resin particle, and the softener in the table indicates solid concentration, and the ion-exchanged water is added such that a total mass of the composition is 100% by mass.

A titanium oxide dispersion (TiO₂ slurry) prepared in advance using the following procedure is used as the titanium oxide pigment. C.I. Pigment White 6 (relative density: 4.2 g/mL) is used as the pigment, and a resin dispersant is used as the pigment dispersant. Specifically, a styrene-acryl resin synthesized using 55% by mass of styrene, 20% by mass of acrylic acid, and 30% by mass of methyl methacrylate is used. One part by mass of the dispersant and 10 parts by mass of the ion-exchanged water are used to mix with three parts by mass of the pigment. The obtained mixture is premixed and then dispersed at a peripheral speed of 10 m/s at a liquid temperature of 30° C. for 15 minutes using zirconia beads having a diameter of 0.03 mm using a bead mill disperser (UAM-015 manufactured by Kotobuki Kogyou Co., Ltd.). Coarse particles are centrifugally separated using a centrifugal separator (Model-3600 manufactured by Kuboyama Shoji Co., Ltd.) to obtain the titanium oxide dispersion.

While not shown in the table, a color ink composition for a color printed matter is obtained by putting each component in a container to obtain the following composition, mixing and stirring for 2 hours with a magnetic stirrer, and then filtering through a membrane filter having a pore size of 5 μm.

Details of “Hydran WLS-201” and “OLFINE E1010” below will be described later. The numerical values in the tables show contents. The content of “Hydran WLS-201” in the tables shows solid concentration.
Color Ink Composition
Pigment Blue 15:3 dispersion 4.0% by mass
Hydran WLS-201 6.0% by mass
Glycerin 8.0% by mass
Ethylene glycol 7.0% by mass
1,2-hexanediol 1.0% by mass
KOH 0.2% by mass
Triethanolamine 1.0% by mass
OLFINE E1010 0.5% by mass
Water Rest

Supplementary descriptions will be provided for the items shown in Tables 1 and 2.
White Ink
Pigment
   ROPAQUE HT1432 (product name, manufactured by Dow Chemical Company, styrene-acrylic resin, hollow particle)
Resin Particle
   Hydran WLS-201 (product name, manufactured by DIC Corporation, urethane resin)
Surfactant
OLFINE E1010 (product name, manufactured by Nissin Chemical Industry Co., Ltd., acetylene glycol-based surfactant)
Treatment Liquid Composition
Softener
   K-45 (product name “High Softener (registered trademark) K-45” manufactured by Meisei Chemical Industry Co., Ltd., particle containing dimethyl silicone, organopolysiloxane, nonionic).
   POLON-MF-14 (product name, manufactured by Shin-Etsu Chemical Co., Ltd., amine-modified silicone emulsion, particle containing organopolysiloxane, nonionic)
   X-51-1264 (product name, manufactured by Shin-Etsu Chemical Co., Ltd., epoxy-modified silicone emulsion, particle containing organopolysiloxane, anionic)
   DCOM35-6 (product name, manufactured by Takamatsu Oil & Fat Co., Ltd., special polyester resin, nonionic) Clear Ink
Resin Particle
TAKELAC W-6061 (product name, manufactured by Mitsui Chemicals, Inc., urethane resin)
Surfactant
   OLFINE E1010 (product name, manufactured by Nissin Chemical Industry Co., Ltd., acetylene glycol-based surfactant)
Second Treatment Liquid Composition
   Unisense KHE103L (product name, manufactured by Senka Corporation, epoxy chlorohydrin-based cationic resin)
Surfactant
   OLFINE E1010 (product name, manufactured by Nissin Chemical Industry Co., Ltd., acetylene glycol-based surfactant)

In “application method” in Tables 1 and 2, “offline” and “IJ” indicate the following.

“Offline”: The fabric used in each example is padded with the second treatment liquid composition according to each example such that a shrinkage rate reaches 60%, and is then dried at 100° C. for 2 minutes. Printing is performed using the fabric.

“IJ”: The second treatment liquid composition according to each example is applied to the fabric using the ink jet method.

In Tables 1 and 2, (1) to (5) in “printing order” are the following orders.

(1):

In the first scanning, the white ink is applied to the fabric.

In the second scanning, the clear ink is applied to the region of the fabric to which the white ink is applied.

In the third scanning, the treatment liquid composition is applied to the region of the fabric to which the white ink is applied.

(2):

In the first scanning, the second treatment liquid composition is applied to the fabric using the ink jet method.

In the second scanning, the white ink is applied to the fabric.

In the third scanning, the clear ink is applied to the region of the fabric to which the white ink is applied.

In the fourth scanning, the treatment liquid composition is applied to the region of the fabric to which the white ink is applied.

(3):

In the first scanning, the second treatment liquid composition and the white ink are applied to the same region of the fabric in the same scanning.

In the second scanning, the treatment liquid composition and the clear ink are applied to the region of the fabric to which the white ink is applied, in the same scanning.

(4):

In the first scanning, the white ink is applied to the fabric.

In the second scanning, the clear ink is applied to the region of the fabric to which the white ink is applied.

(5):

In the first scanning, the white ink is applied to the fabric.

In the second scanning, the treatment liquid composition is applied to the region of the fabric to which the white ink is applied.

### 3.2 Production of Printed Matter

### Setting for Printing

Printing was performed using a device modified from ML-8000 (manufactured by Seiko Epson Corporation). Resolution for printing is set to 1200 dpi×1200 dpi, and a driving amount for printing with 100% duty is set to 24.3 mL/m². Application of the white ink to the fabric is 400% duty. Application of the treatment liquid composition to the fabric is 50% duty. Application of the clear ink to the fabric is 100% duty. Application of the second treatment liquid composition to the fabric using the ink jet method is 100% duty.

### Printing Method (White Only)

Each composition is applied to the fabric based on the printing order of each example shown in Tables 1 and 2. Then, heat treatment is performed at 160° C. or 140° C. for three minutes using an oven. Hereinafter, the printed matter printed without using the color ink composition will be referred to as a “white printed matter”.

### Printing Method (Color)

The compositions were applied to the fabric based on the printing order of each example shown in Tables 1 and 2. Here, scanning in which the color ink composition is applied with 100% duty to the region of the fabric to which the white ink is applied is additionally performed in the subsequent scanning to scanning in which the white ink is applied in “printing order” in Tables 1 and 2. Then, heat treatment is performed at 160° C. or 140° C. for three minutes using an oven. Hereinafter, the printed matter printed using the color ink composition will be referred to as a “color printed matter”.

### 3.3 Evaluation Method

### 3.3.1 Color Developing Property

For the above obtained white printed material according to each example, the value of L* in the CIE/L*a*b* color system is measured using a colorimeter Gretag Macbeth Spectrolino (manufactured by X-Rite), and the color developing property is evaluated based on the following evaluation criteria.

### Evaluation Criteria

AA: L* of 80 or more
A: L* of 75 or more
B: L* of 70 or more
C: L* less than 70

### 3.3.2 (Dry) Rubbing Fastness

The above obtained color printed matter according to each example is subjected to a drying test in accordance with the ISO 105 X12 standard and is visually observed to evaluate (dry) rubbing fastness based on the following evaluation criteria.

### Evaluation Criteria

AA: Not worn or peeled
A: Surface looks rough, but peeling does not occur.
C: Peeled

### 3.3.3 Texture

Texture of the above obtained white printed matter according to each example is evaluated through sensory evaluation. Specifically, any five examiners are asked to answer with any of “comparable to the original feel of the fabric” and “the textile-printed fabric is rough, and the original feel of the fabric is impaired”, and evaluation is performed based on the following criteria.

### Evaluation Criteria

AA: Five examiners answer with “comparable to the original feel of the fabric”.
A: Three or more and less than five examiners answer with “comparable to the original feel of the fabric”.
B: One or more and less than three examiners answer with “comparable to the original feel of the fabric”.
C: Zero examiners answer with “comparable to the original feel of the fabric”.

### 3.3.4 Stability of Continuous Printing

After performing continuous printing for 1 hour under the printing condition for the “white printed matter”, the nozzles are checked, and the number of missing nozzles is counted to evaluate stability of continuous printing based on the following evaluation criteria. The number of missing nozzles is its average in five tests.

### Evaluation Criteria

AA: 0 to less than 0.5
A: 0.5 to less than 1
B: 1 to less than 2
C: 2 or more
   3.4 Evaluation result

An evaluation result is shown in Tables 1 and 2.

From the result in Tables 1 and 2, any of each example using the composition set including the textile printing white ink jet ink composition, the textile printing clear ink jet ink composition, and the treatment liquid composition, in which the textile printing white ink jet ink composition contains the titanium oxide pigment and the water, the textile printing clear ink jet ink composition contains the resin particle and the water, and the treatment liquid composition contains the particle containing the organopolysiloxane, and the water can achieve favorable color developing property and texture while achieving more favorable rubbing fastness.

Meanwhile, each comparative example using a composition set not satisfying the above configuration deteriorates in at least one of rubbing fastness, the color developing property, and texture.

The following contents are derived from the above embodiment.

A composition set of an aspect includes a textile printing white ink jet ink composition, a textile printing clear ink jet ink composition, and a treatment liquid composition, in which the textile printing white ink jet ink composition contains a titanium oxide pigment and water, the textile printing clear ink jet ink composition contains a resin particle and water, and the treatment liquid composition contains a particle containing organopolysiloxane and water.

In the aspect of the composition set, the organopolysiloxane may be nonionic silicone.

In any aspect of the composition set, the organopolysiloxane may be dimethyl silicone.

In any aspect of the composition set, a content of the particle containing the organopolysiloxane may be 5% to 15% by mass with respect to a total amount of the treatment liquid composition.

In any aspect of the composition set, the treatment liquid composition may be ejected and used by an ink jet method.

In any aspect of the composition set, a content of the titanium oxide pigment may be 8.3% to 11.8% by mass with respect to a total amount of the textile printing white ink jet ink composition.

In any aspect of the composition set, the textile printing white ink jet ink composition may further contain 3.0% to 20.0% by mass of a resin particle.

In any aspect of the composition set, a content of the resin particle in the textile printing clear ink jet ink composition may be 1.2 or more with respect to a content of the resin particle in the textile printing white ink jet ink composition.

In any aspect of the composition set, a content of the resin particle may be 7.0% by mass or more with respect to a total amount of the textile printing clear ink jet ink composition.

The composition set of any aspect may further include a second treatment liquid composition containing an agglomerating agent for agglomerating a component in an ink, and water.

In any aspect of the composition set, the second treatment liquid composition may be ejected and used by an ink jet method.

In any aspect of the composition set, the agglomerating agent may be a polyvalent metal salt.

In any aspect of the composition set, a content of the agglomerating agent may be 3.5% to 8.5% by mass with respect to a total amount of the second treatment liquid composition.

In any aspect of the composition set, a content of the particle containing the organopolysiloxane in the treatment liquid composition may be greater than a content of the resin particle in the textile printing white ink jet ink composition.

In any aspect of the composition set, a content of the particle containing the organopolysiloxane in the treatment liquid composition may be less than a content of the resin particle in the textile printing clear ink jet ink composition.

An ink jet recording method of another aspect is performed using the composition set of any aspect and includes a white ink jet ink application step of applying the textile printing white ink jet ink composition to a fabric using an ink jet method, a treatment liquid application step of applying the treatment liquid composition to a region of the fabric to which the textile printing white ink jet ink composition is applied, and a clear ink application step of applying the textile printing clear ink jet ink composition to the region of the fabric to which the textile printing white ink jet ink composition is applied.

In the aspect of the ink jet recording method, the treatment liquid application step may be performed simultaneously with the clear ink application step.

The ink jet recording method of any aspect may further include a second treatment liquid application step of applying a second treatment liquid composition to the fabric using the ink jet method, in which the composition set further includes the second treatment liquid composition containing an agglomerating agent for agglomerating a component in an ink, and water, and the second treatment liquid application step is performed simultaneously with the white ink jet ink application step.

The ink jet recording method of any aspect may further include a drying step of drying the fabric by heating the fabric at 160° C. or higher after the treatment liquid application step and the clear ink application step.

In any aspect of the ink jet recording method, the fabric may be a colored cotton fabric.

The present disclosure is not limited to the above embodiment, and various modifications can be made. For example, the present disclosure includes substantially the same configurations as the configurations described in the embodiment, such as configurations having the same function, method, and result or configurations having the same object and effect. The present disclosure also includes configurations obtained by replacing non-essential parts of the configurations described in the embodiment. The present disclosure also includes configurations achieving the same action and effect or configurations that can achieve the same object as the configurations described in the embodiment. The present disclosure also includes configurations obtained by adding a well-known technology to the configurations described in the embodiment.

What is claimed is:

1. A composition set comprising:
a textile printing white ink jet ink composition;
a textile printing clear ink jet ink composition; and
a treatment liquid composition, wherein
the textile printing white ink jet ink composition contains a titanium oxide pigment and water,
the textile printing clear ink jet ink composition contains a resin particle and water, and
the treatment liquid composition contains a particle containing organopolysiloxane and water.

2. The composition set according to claim 1, wherein
the organopolysiloxane is nonionic silicone.

3. The composition set according to claim 1, wherein
the organopolysiloxane is dimethyl silicone.

4. The composition set according to claim 1, wherein
a content of the particle containing the organopolysiloxane is 5% to 15% by mass with respect to a total amount of the treatment liquid composition.

5. The composition set according to claim 1, wherein
the treatment liquid composition is ejected and used by an ink jet method.

6. The composition set according to claim 1, wherein
a content of the titanium oxide pigment is 8.3% to 11.8% by mass with respect to a total amount of the textile printing white ink jet ink composition.

7. The composition set according to claim 1, wherein
the textile printing white ink jet ink composition further contains 3.0% to 20.0% by mass of a resin particle.

8. The composition set according to claim 7, wherein
a content of the resin particle in the textile printing clear ink jet ink composition is 1.2 or more with respect to a content of the resin particle in the textile printing white ink jet ink composition.

9. The composition set according to claim 1, wherein
a content of the resin particle is 7.08 by mass or more with respect to a total amount of the textile printing clear ink jet ink composition.

10. The composition set according to claim 1, further comprising:
a second treatment liquid composition containing an agglomerating agent for agglomerating a component in an ink, and water.

11. The composition set according to claim 10, wherein
the second treatment liquid composition is ejected and used by an ink jet method.

12. The composition set according to claim 10, wherein
the agglomerating agent is a polyvalent metal salt.

13. The composition set according to claim 10, wherein
a content of the agglomerating agent is 3.5% to 8.5% by mass with respect to a total amount of the second treatment liquid composition.

14. The composition set according to claim 7, wherein
a content of the particle containing the organopolysiloxane in the treatment liquid composition is greater than a content of the resin particle in the textile printing white ink jet ink composition.

15. The composition set according to claim 1, wherein
a content of the particle containing the organopolysiloxane in the treatment liquid composition is less than a content of the resin particle in the textile printing clear ink jet ink composition.

16. An ink jet recording method performed using the composition set according to claim 1, comprising:
a white ink jet ink application step of applying the textile printing white ink jet ink composition to a fabric using an ink jet method;
a treatment liquid application step of applying the treatment liquid composition to a region of the fabric to which the textile printing white ink jet ink composition is applied; and
a clear ink application step of applying the textile printing clear ink jet ink composition to the region of the fabric to which the textile printing white ink jet ink composition is applied.

17. The ink jet recording method according to claim 16, wherein
the treatment liquid application step is performed simultaneously with the clear ink application step.

18. The ink jet recording method according to claim 16, further comprising:
a second treatment liquid application step of applying a second treatment liquid composition to the fabric using the ink jet method, wherein
the composition set further includes the second treatment liquid composition containing an agglomerating agent for agglomerating a component in an ink, and water, and
the second treatment liquid application step is performed simultaneously with the white ink jet ink application step.

19. The ink jet recording method according to claim 16, further comprising:
a drying step of drying the fabric by heating the fabric at 160° C. or higher after the treatment liquid application step and the clear ink application step.

20. The ink jet recording method according to claim 16, wherein
the fabric is a colored cotton fabric.
